(19) United States
(12) Patent Application Publication
(10) Pub. No.: US 2008/0151715 A1
(43) Pub. Date: Jun. 26, 2008

(54) Disc Apparatus

(75) Inventor: Masaki MATAGA, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/963,013

(22) Filed: Dec. 21, 2007

(30) Foreign Application Priority Data
Dec. 22, 2006 (JP) 2006-345113

(51) Int. Cl. G11B 5/00

(52) U.S. Cl. 369/47.53

(57) ABSTRACT

A disc apparatus comprises: an optical pickup for irradiating a laser beam onto an optical disc; a reproduction signal detection unit for detecting a reproduction signal when reproducing data; a modulation detection unit for detecting modulation of the reproduction signal; an asymmetry detection unit for detecting asymmetry of the reproduction signal; and a control unit for controlling the power and the cooling pulse width of the laser beam based on the modulation and the asymmetry. The control unit controls such that when the modulation is lower than 0.6, the control unit increases the power of the laser beam, while when the asymmetry is lower than −0.05, the control unit increases the cooling pulse width of the laser beam. This makes it possible for the disc apparatus to smoothly reproduce the data without disturbance in the reproduced data regardless of a tilt of, or a recording position on, the optical disc.

### BACKGROUND OF THE INVENTION

1. Field of the Invention

The present invention relates to a disc apparatus for recording data on an optical disc by irradiating a laser beam thereon.

2. Description of the Related Art

In a disc apparatus for recording data on an optical disc such as CD-R (Compact Disc Recordable) and DVD (Digital Versatile Disc), a laser beam is irradiated onto the optical disc to form pits so as to record the data. For reproduction of the recorded data, the disc apparatus irradiates a laser beam onto the pits, while a photodetector of the disc apparatus receives reflected light of the laser beam irradiated onto the pits. It is desirable that the data is reproduced in a state where its jitter, which refers to fluctuations in time of the reproduction signal, is low. Further, it is desirable that each pit has a good shape with a constant width and a sharp edge at a trailing end thereof. It is known that if the pits have a good shape, the jitter can be reduced to a low level.

The disc apparatus is required to irradiate a laser beam with an optimum power and an optimum pulse width in order to form pits having a good shape. Thus, before recording data, the disc apparatus determines an optimum power of a laser beam by so-called OPC (Optimum Power Control) so as to irradiate a laser beam with the determined power. However, the power of the laser beam to enable the formation of pits having a good shape varies with inclination (tilt) of an optical disc. In addition, depending on the method of manufacturing the optical disc, it may not be possible to form pits having a good shape in an outer circumferential area of the optical disc although it may be possible in an inner circumferential area of the optical disc. A solution to avoid this problem may be to prevent data from being recorded in the outer circumferential area of the optical disc. However, this solution has a problem of causing a data recording area of the optical disc to be reduced, preventing effective use of the optical disc.

Japanese Laid-open Patent Publication 2006-127593 discloses a technology to obtain an optimum power of a laser beam based on an amplitude of an RF signal which is obtained to reproduce recorded data, and a low frequency component of which is removed. Further, Published Japanese Translation of PCT Application 2003-505807 discloses a technology to compare an amount of a laser beam reflected from an optical disc with a predetermined reference value so as to set a power of the laser beam when recording data. Although the technologies disclosed in these two patent publications can adjust the power of the laser beam, they cannot set a pulse width of the laser beam so that they may not be able to form pits having a good shape.

On the other hand, Japanese Laid-open Patent Publication 2002-279674 discloses a technology to record data using a power of a laser beam which allows the asymmetry of reproduction signals to be substantially zero. However, in the technology of this patent publication, the power of the laser beam to allow the asymmetry to be substantially zero is not necessarily an optimum power of the laser beam, because an optimum power of the laser beam varies with a radial position of an optical disc for recording data. In addition, Japanese Laid-open Patent Publication Hei 3-259434 discloses a technology to vary the power and the pulse width of a laser beam according to a position on an optical disc for recording data. However, in the technology of this patent publication, it is not always possible to obtain a power and a pulse with of the laser beam which can form pits having a good shape, because an optimum power and pulse width of the laser beam also varies with a tilt of the optical disc so as not to be uniquely determined by the position on the optical disc for recording data.

### SUMMARY OF THE INVENTION

An object of the present invention is to provide a disc apparatus for recording data on an optical disc by irradiating a laser beam onto the optical disc, which regardless of a tilt of the optical disc or a position on the optical disc for recording data, obtains a power and a pulse width of the laser beam to enable recording of data to be reproduced with its jitter being reduced to a low level, and records the data using the obtained power and pulse width of the laser beam.

According to the present invention, this object is achieved by a disc apparatus comprising: a photoemitter for irradiating a laser beam onto an optical disc for recording/reproducing data on/from the optical disc; a photodetector for receiving the laser beam reflected by the optical disc so as to reproduce data composed of data segments recorded on the optical disc; a control unit for controlling a power and a cooling pulse width of the laser beam; a reproduction signal detection unit for detecting a reproduction signal from the laser beam received by the photodetector; and a characteristic detection unit for detecting modulation or asymmetry of the reproduction signal detected by the reproduction signal detection unit, wherein when the photoemitter records a data segment of the data on the optical disc, the control unit controls the reproduction signal detection unit to detect a reproduction signal of the data segment recorded on the optical disc, and wherein when the modulation or the asymmetry of the reproduction signal detected by the characteristic detection unit is lower than a predetermined value, the control unit increases the power or the cooling pulse width of the laser beam.

In the disc apparatus as structured above, when the photoemitter records a data segment on the optical disc, the control unit adjusts the power or the cooling pulse width of the laser beam based on the modulation or the asymmetry of the reproduction signal of the data segment just recorded on the optical disc. This makes it possible for the photoemitter to record, on the optical disc, data which can be reproduced smoothly without disturbance in the reproduced data regardless of a tilt of, or a recording position on, the optical disc.

Preferably, the characteristic detection unit comprises a modulation detection unit for detecting the modulation of the reproduction signal and an asymmetry detection unit for detecting the asymmetry of the reproduction signal, wherein when the modulation of the reproduction signal detected by the modulation detection unit is lower than a predetermined modulation value, the control unit controls the photoemitter to increase the power of the laser beam, while when the asymmetry of the reproduction signal detected by the asymmetry detection unit is lower than a predetermined asymmetry value, the control unit controls the photoemitter to increase the cooling pulse width of the laser beam. This makes it possible for the disc apparatus to more readily achieve the above-described object.

Further preferably, the predetermined modulation value is 0.6, while the predetermined asymmetry value is −0.05. This makes it possible for the disc apparatus to yet more readily achieve the above-described object.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic block diagram of a disc apparatus according to an embodiment of the present embodiment;

FIG. 2 is a flow chart of a process of recording data on an optical disc according to the embodiment of the present invention;

FIG. 3 is a graph showing the variation of the jitter and the modulation of a reproduction signal with the recording position of the optical disc; and

FIG. 4 is a graph showing the variation of the jitter and the asymmetry of a reproduction signal with the recording position.

### DESCRIPTION OF THE PREFERRED EMBODIMENTS

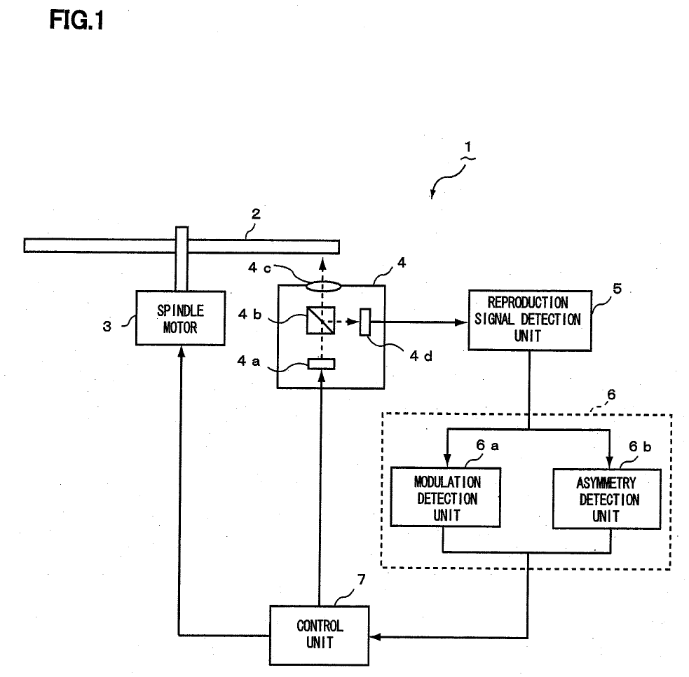

A disc apparatus 1 according to an embodiment of the present invention will be described hereinafter with reference to the annexed drawings. It is to be understood that the embodiments described herein are not intended as limiting, or encompassing the entire scope of, the invention. FIG. 1 is a schematic block diagram of a disc apparatus 1 according to the present embodiment. The disc apparatus 1 comprises: a spindle motor 3 for rotating an optical disc 2; an optical pickup 4 for irradiating a laser beam onto the optical disc 2; a reproduction signal detection unit (circuit) 5 for detecting a reproduction signal from light reflected by the optical disc 2; a characteristic detection unit 6 having a modulation detection unit 6a for detecting modulation of the reproduction signal from the reproduction signal, and also having an asymmetry detection unit 6b for detecting asymmetry of the reproduction signal from the reproduction signal; and a control unit 7 for controlling a power and a pulse width of the laser beam irradiated by the optical pickup 4 based on the modulation and the asymmetry detected by the modulation detection unit 6a and the asymmetry detection unit 6b. The control unit 7 also controls the spindle motor 3. Here, the optical disc 2 is, for example, a DVD (Digital Versatile Disc)−RW (Minus Rewritable) or a DVD+RW (Plus Rewritable).

The optical pickup 4 comprises: a semiconductor laser 4a (photoemitter or light emitting element) for irradiating a laser beam onto the optical disc 2 under the control of, or in response to a command of, the control unit 7; a beam splitter 4b for passing the laser beam irradiated from the semiconductor laser 4a; and an objective lens 4c for collecting the laser beam passing through the beam splitter 4b onto the optical disc 2. The laser beam from the objective lens 4c is reflected by the optical disc 2 as reflected light to return to the beam splitter 4b. The beam splitter 4b changes the direction of the reflected light. The optical pickup 4 further comprises a photodetector 4d (light receiving element) for receiving the reflected light from the optical disc 2 (laser beam reflected by the optical disc 2) which is changed in direction by the beam splitter 4b, and for outputting a signal based on the reflected light to the reproduction signal detection unit 5.

When the disc apparatus 1 records data on the optical disc 2, the control unit 7 determines the power of a laser beam by OPC (Optimum Power Control). Here, OPC is a method of determining an optimum power of the laser beam for data recording by writing data in a data trial writing area prepared on the optical disc 2 while changing the power of the laser beam, and by reproducing the thus written data. The semiconductor laser 4a irradiates, onto the optical disc 2, a laser beam with a power determined by OPC and with a predetermined pulse width so as to form pits thereon, thereby recording data. If the thus formed or recorded pits do not have a good shape, the disc apparatus 1 is not able to read (reproduce) the recorded data smoothly without disturbance in reproduced data such as reproduced images. Here, the term “good shape of a pit” is used to mean that the pit has a shape of constant width and sharp edge at a trailing end thereof. Further, the term “smooth reading (reproduction) without disturbance in reproduced data” is used to mean that the disc apparatus 1 reads (reproduces) recorded data normally such as reproducing the recorded data with a low error rate and reproducing the data without a delay in the display of the reproduced data.

The reproduction of the recorded data on the optical disc 2 is performed by the reproduction signal detection unit 5, which detects a reproduction signal of the recorded data based on reflected light of the laser beam irradiated onto the pits on the optical disc 2. If the pits do not have a good shape, the reflected light of the laser beam irradiated onto the pits becomes disordered, so that the jitter of the reproduction signal, which refers to fluctuations in time of the reproduction signal, becomes high, making it unable to reproduce the data smoothly without disturbance in the reproduced data. Thus, the semiconductor laser 4a irradiates a laser beam with an optimum power according to the kind of the optical disc 2, so as to form pits on the optical disc 2 which make it possible to reduce the jitter of the reproduction signal when reproducing the data.

In addition, in order to prevent pit distortion caused by an expansion of a pit at its trailing end due to heat accumulation when forming the pit, the semiconductor laser 4a irradiates a laser beam by the known multi-pulse method, which uses multiple pulses having a write power (high power) level or a bias power (low power) level with appropriate pulse widths. More specifically, when forming pits or recording data, the semiconductor laser 4a irradiates a laser beam (write pulse) set at the write power level with a top pulse width, and thereafter irradiating a laser beam (multi-pulse) alternately set at the write power level and the bias power level with a multi-pulse width. Finally, the semiconductor laser 4a irradiates a laser beam (cooling pulse) set at the bias power level with a cooling pulse width. The cooling pulse is used for the purpose of quenching a formed pit so as to prevent the pit from having distortion, and at the same time allow the pit to have a sharp edge at a trailing end thereof.

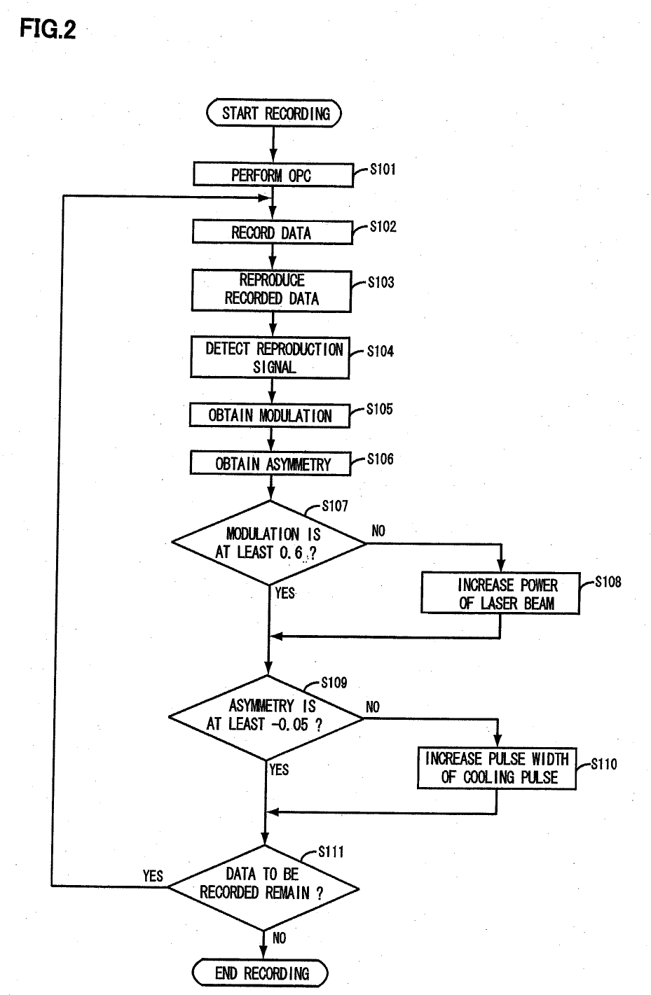

However, an optimum power of a laser beam to form pits having a good shape varies with a radial position (recording position) on the optical disc 2 to record data, and with the kind of optical disc 2, and also with a tilt of the optical disc 2. Accordingly, even if the semiconductor laser 4a irradiates a laser beam with a power determined by OPC, it may not be possible to form pits having a good shape on the optical disc 2. In particular, depending on the method of manufacturing the optical disc 2, it may not be possible to form pits having a good shape in an outermost circumferential area of the optical disc 2 by using the power of a laser beam determined by OPC. Thus, the following describes, with reference to FIG. 2, a process of recording data which enables the formation of pits having a good shape even in an outermost circumferential area of the optical disc 2.

FIG. 2 is a flow chart of a process of recording data in the disc apparatus 1 according to the present embodiment. When starting recording data on the optical disc 2, the control unit 7 performs OPC to determine a power of a laser beam for the semiconductor laser 4a to irradiate onto the optical disc 2 for data recording (S101). In a first process, the control unit 7 controls to record, by OPC on one recording position (radial position) of the optical disc 2, a portion of data to be recorded that is pre-recorded data stored in a buffer memory (not shown). In a second (next) process, the control unit 7 controls to record, on another recording position (for example, adjacent recording position) of the optical disc 2, another portion of pre-recorded data stored in the buffer memory. In this way, the control unit 7 performs such processes sequentially to complete the recording of the pre-recorded data stored in the buffer memory. This will be described below in detail.

Under the control of the control unit 7, the semiconductor laser 4a irradiates a laser beam with a power determined by the control unit 7 onto one recording position of the optical disc 2 so as to form, on the one recording position of the optical disc 2, pits corresponding to a first portion of data stored in the buffer memory, and thereby record the first portion of data on the optical disc 2 (S102). In the present specification, a portion of data stored in the buffer memory and used to be recorded in step S102, which is in one cycle of recording according to the flow chart of FIG. 2, is referred to as a “data segment”, so that the first portion of data can be referred to as “first data segment”.

When a predetermined number of pits corresponding to the first data segment are formed on the one recording position of the optical disc 2, the control unit 7 controls the optical pickup 4 to stop the data recording, and then controls the optical pickup 4 and the reproduction signal detection unit 5 to reproduce the recorded first data segment, i.e. just recorded data segment, from the one recording position of the optical disc 2 (S103). More specifically, the semiconductor laser 4a irradiates the laser beam onto the just formed pits. The photodetector 4d receives reflected light of the laser beam irradiated onto and reflected from the just formed pits of the recorded first data segment, and generates and outputs a signal based on the reflected light to the reproduction signal detection unit 5.

The reproduction signal detection unit 5 detects or extracts a reproduction signal from the signal received from the photodetector 4d (S104), and outputs the reproduction signal to the characteristic detection unit 6, more specifically to the modulation detection unit 6a and the asymmetry detection unit 6b. The modulation detection unit 6a detects or extracts modulation (modulation value) of the reproduction signal from the reproduction signal received thereby, and notifies or sends the detected modulation of the reproduction signal to the control unit 7 (S105). On the other hand, the asymmetry detection unit 6b detects or extracts asymmetry (asymmetry value) of the reproduction signal from the reproduction signal received thereby, and notifies or sends the detected asymmetry of the reproduction signal to the control unit 7 (S106).

Since the jitter of the reproduction signal becomes high when the modulation (modulation value) of the reproduction signal is lower than 0.6, the control unit 7 determines whether or not the modulation of the reproduction signal received from the modulation detection unit 6a is at least 0.6 (S107). When the power of the laser beam increases (decreases), the modulation of the reproduction signal increases (decreases). Thus, if the control unit 7 determines in step S107 that the modulation of the reproduction signal is lower than 0.6 (NO in S107), the control unit 7 further determines that the power of the laser beam is not sufficient, and controls the semiconductor laser 4a to increase the power of the laser beam (S108), for example, by 1 mW. On the other hand, if the control unit 7 determines in step S107 that the modulation of the reproduction signal is at least (equal to or higher than) 0.6 (YES in S107), then the control unit 7 further determines, without increasing the power of the laser beam, whether or not the asymmetry (asymmetry value) of the reproduction signal received from the asymmetry detection unit 6b is at least (equal to or higher than) −0.05 (S109). If the asymmetry of the reproduction signal is determined in step S109 to be lower than −0.05, it is considered that the pits have distortion in shape.

This pit distortion is caused by insufficient cooling of the pits when formed, and can be eliminated or reduced by increasing the pulse width of the cooling pulse (i.e. cooling pulse width) when the semiconductor laser 4a irradiates the laser beam. Thus, if the control unit 7 determines in step S109 that the asymmetry of the reproduction signal is lower than −0.05 (NO in S109), the control unit 7 further determines that the pits have distortion in shape, and controls the semiconductor laser 4a to increase the pulse width of the cooling pulse when the semiconductor laser 4a irradiates the laser beam (S110), for example, by 0.05T, where T is a reference clock period of the laser beam.

On the other hand, if the control unit 7 determines in step S109 that the asymmetry of the reproduction signal is at least (equal to or higher than) −0.05 (YES in S109), then the control unit 7 further determines whether or not data (data segments) to be recorded (prerecorded data or data) remain in the buffer memory (S111). If there remain data (data segments) to be recorded or pre-recorded data in the buffer memory, the process goes back to step S102, in which the control unit 7 controls the semiconductor laser 4a to record, on another (e.g. adjacent) recording position of the optical disc 2, another portion of the pre-recorded data, i.e. a second data segment, stored in the buffer memory, and controls to repeat steps S102 to S111 described above. If there remain no data (no data segment) to be recorded or pre-recorded data in the buffer memory (NO in S111), the control unit 7 controls to end recording data.

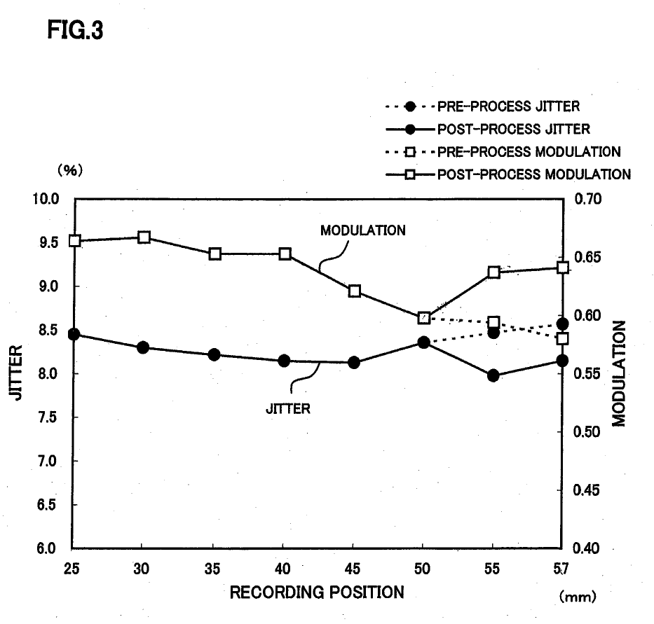

Next, referring to FIG. 3, the relationship between the jitter and the modulation of reproduction signals in the disc apparatus 1 according to the present embodiment will be described. FIG. 3 is a graph showing the variation of the jitter and the modulation of a reproduction signal with the recording position (radial position) of the optical disc 2. In FIG. 3, the left vertical axis represents jitter value in percent, and the right vertical axis represents modulation value, while the horizontal axis represents recording position on the optical disc 2, that is a radial position from the center of the optical disc 2 on which data is recorded. Further, the dashed lines are the variations of the modulation and the jitter of reproduction signals before the process of the disc apparatus 1 of the present embodiment is applied, that are pre-process modulation and pre-process jitter, while the solid lines are those after such process is applied, that are post-process modulation and post-process jitter.

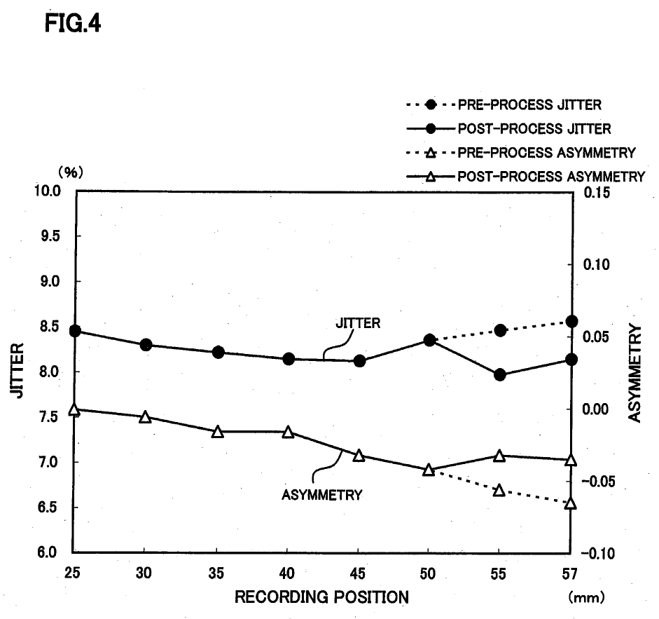

Generally, a disc apparatus having an OPC function is designed to achieve as good jitter performance as possible. For this purpose, the disc apparatus is designed to allow reproduction signals to have a higher modulation value such as 0.6 or higher, and a higher asymmetry value such as −0.05 or higher. However, for some reason, these values may be undesirably low. FIG. 3 (and FIG. 4 below) shows a case where the modulation value becomes lower than 0.6 (and the asymmetry value becomes lower than −0.05) depending on the recording position of the optical disc 2. Referring to the graph of FIG. 3, the modulation values in a range of recording positions of data from 25 mm to 50 mm are at least 0.6, so that the control unit 7 does not increase the power of the laser beam in this range of recording positions from 25 mm to 50 mm. Thus, in this range of recording positions, all the values of the pre-process modulation are the same as those of the post-process modulation. When the values of the pre-process modulation are the same as those of the post-process modulation, all the values of the pre-process jitter are the same as those of the post-process jitter.

FIG. 3 further shows that the values of the pre-process modulation are lower than 0.6 in a range of recording positions of data beyond 50 mm. This indicates that in this range of recording positions beyond 50 mm, the power of the laser beam is insufficient. FIG. 3 also shows that when the values of the pre-process modulation are lower than 0.6, the values of the pre-process jitter exceed 8.5%. Here, the disc apparatus 1 is set so that a jitter value exceeding 8.5% needs to be lowered in order to reproduce data more smoothly with less disturbance in the reproduced data (i.e. reproduce data with a lower error rate and less delay in the display of the reproduced data). FIG. 3 indicates that in a range of recording positions from 50 mm to 57 mm, the values of the pre-process jitter exceed 8.5% which, under the above setting, needs to be lowered in order to reproduce data more smoothly with less disturbance in the reproduced data. Thus, when the values of the pre-process modulation are lower than 0.6, the control unit 7 controls the semiconductor laser 4a to increase the power of the laser beam e.g. by 1 mW.

More specifically, after the semiconductor laser 4a irradiates a laser beam with a certain power (previously set power) under the control of the control unit 7 to record a data segment on a recording position of the optical disc 2, the semiconductor laser 4 irradiates a laser beam with a power increased e.g. by 1 mW from the certain power to record a subsequent data segment on a subsequent (e.g. adjacent) recording position of the optical disc 2. After each data segment is recorded, the modulation value of the reproduction signal of the each data segment is detected and determined as to whether or not the modulation value is lower than 0.6. Until the modulation value of 0.6 is reached, the power of the laser beam is increased by 1 mW for the subsequent data segment recording.

The solid line of modulation shown in FIG. 3 in the range of recording positions from 50 mm to 57 mm indicates that the modulation values after the laser power increase (i.e. post-process modulation) are made higher than those before the laser power increase (i.e. pre-process modulation). According to the post-process modulation values, which become higher than the pre-process modulation values in the range of recording positions from 50 mm to 57 mm, the post-process jitter values become lower than, or reduced from, the pre-process jitter values in this range of recording positions. The reduction of the post-process jitter values means that the recorded data can be reproduced more smoothly with less disturbance in the reproduced data, which indicates that by increasing the power of the laser beam, pits having a good or better shape are formed even in an outer circumferential area of the optical disc 2.

Next, referring to FIG. 4, the relationship between the jitter and the asymmetry of reproduction signals in the disc apparatus 1 according to the present embodiment will be described. FIG. 4 is a graph showing the variation of the jitter and the asymmetry of a reproduction signal with the recording position (radial position) of the optical disc 2. In FIG. 4, the left vertical axis represents jitter value in percent, and the right vertical axis represents asymmetry value, while the horizontal axis represents recording position on the optical disc 2, that is a radial position from the center of the optical disc 2 on which data is recorded. Further, the dashed lines are the variations of the asymmetry and the jitter of reproduction signals before the process of the disc apparatus 1 of the present embodiment is applied, that are pre-process asymmetry and pre-process jitter; while the solid lines are those after such process is applied, that are post-process asymmetry and post-process jitter.

A general disc apparatus is designed to allow reproduction signals to have a higher asymmetry value such as −0.05 or higher. However, for some reason, these values may be undesirably low. FIG. 4 shows a case where the asymmetry value becomes lower than −0.05 depending on the recording position of the optical disc 2. Referring to the graph of FIG. 4, the asymmetry values in a range of recording positions of data from 25 mm to 50 mm are at least −0.05, so that the control unit 7 does not increase the pulse width of the cooling pulse of the laser beam in this range of recording positions from 25 mm to 50 mm. Thus, in this range of recording positions, all the values of the pre-process asymmetry are the same as those of the post-process asymmetry. When the values of the pre-process asymmetry are the same as those of the post-process asymmetry, all the values of the pre-process jitter are the same as those of the post-process jitter.

FIG. 4 further shows that the values of the pre-process asymmetry are lower than −0.05 in a range of recording positions of data beyond 50 mm. This indicates that in this range of recording positions beyond 50 mm, the pulse width of the cooling pulse of the laser beam is insufficient. FIG. 4 also shows that when the values of the pre-process asymmetry are lower than −0.05, the values of the pre-process jitter exceed 8.5%. As described above, the disc apparatus 1 is set so that a jitter value exceeding 8.5% needs to be lowered in order to reproduce data more smoothly with less disturbance in the reproduced data (i.e. reproduce data with a lower error rate and less delay in the display of the reproduced data). FIG. 4 indicates that in a range of recording positions from 50 mm to 57 mm, the values of the pre-process jitter exceed 8.5% which, under the above setting, needs to be lowered in order to reproduce data more smoothly with less disturbance in the reproduced data. Thus, when the values of the pre-process asymmetry are lower than −0.05, the control unit 7 controls the semiconductor laser 4a to increase the pulse width of the cooling pulse of the laser beam e.g. by 0.05T.

More specifically, after the semiconductor laser 4a irradiates a laser beam with a certain pulse width of the cooling pulse (previously set pulse width) under the control of the control unit 7 to record a data segment on a recording position of the optical disc 2, the semiconductor laser 4 irradiates a laser beam with a pulse width of the cooling pulse increased e.g. by 0.05T from the certain pulse width to record a subsequent data segment on a subsequent (e.g. adjacent) recording position of the optical disc 2. After each data segment is recorded, the asymmetry value of the reproduction signal of the each data segment is detected and determined as to whether the asymmetry value is lower than −0.05. Until the asymmetry value of −0.05 is reached, the pulse width of the cooling pulse of the laser beam is increased by 0.05T for the subsequent data segment recording.

The solid line of asymmetry shown in FIG. 4 in the range of recording positions from 50 mm to 57 mm indicates that the asymmetry values after the pulse width increase (i.e. post-process asymmetry) are made higher than those before the pulse width increase (i.e. pre-process asymmetry). According to the post-process asymmetry values, which become higher than the pre-process asymmetry values in the range of recording positions from 50 mm to 57 mm, the post-process jitter values become lower than, or reduced from, the pre-process jitter values in this range of recording positions. The reduction of the post-process jitter values means that the recorded data can be reproduced more smoothly with less disturbance in the reproduced data, which indicates that by increasing the pulse width of the cooling pulse of the laser beam, pits having a good or better shape are formed even in an outer circumferential area of the optical disc 2.

As described in the foregoing, the control unit 7 of the disc apparatus 1 according to the present embodiment controls the semiconductor laser (photoemitter) 4a to increase the power of the laser beam when the modulation value of the reproduced signal is lower than 0.6, while the control unit 7 controls the semiconductor laser 4a to increase the pulse width of the cooling pulse when the asymmetry value of the reproduced signal is lower than −0.05. This makes it possible for the disc apparatus 1 to record data to be reproduced (read) with a low error rate without a delay in the display of the reproduced data, or in short, to be reproduced smoothly without disturbance in the reproduced data, regardless of a tilt of, or a recording position on, the optical disc 2 to record data.

It is to be noted that the present invention is not limited to the above-described specific embodiments, and various modifications can be made within the scope of the present invention. For example, the characteristic detection unit 6 of the disc apparatus 1 described above comprises the modulation detection unit 6a and the asymmetry detection unit 6b which are separate from each other. However, the characteristic detection unit 6 can be designed as one characteristic detection unit which can detect, from a reproduction signal, either one or both modulation (modulation value) and asymmetry (asymmetry value) of the reproduction signal. In addition, in the above-described embodiment, the modulation value of 0.6 and the asymmetry value of −0.05 are used for the control of the control unit 7. However, these values can be changed, for example, to 0.625 and −0.04, respectively, such that when the detected modulation value is lower than 0.625, the control unit 7 controls to increase the power of the laser beam, while when the detected asymmetry value is lower than −0.04, the control unit 7 controls to increase the pulse width of the cooling pulse.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2006-345113 filed Dec. 22, 2006, the content of which is hereby incorporated by reference.

What is claimed is:

1. A disc apparatus comprising:
a photoemitter for irradiating a laser beam onto an optical disc for recording/reproducing data on/from the optical disc;
a photodetector for receiving the laser beam reflected by the optical disc so as to reproduce data composed of data segments recorded on the optical disc;
a control unit for controlling a power and a cooling pulse width of the laser beam;
a reproduction signal detection unit for detecting a reproduction signal from the laser beam received by the photodetector; and
a characteristic detection unit for detecting modulation or asymmetry of the reproduction signal detected by the reproduction signal detection unit,
wherein when the photoemitter records a data segment of the data on the optical disc, the control unit controls the reproduction signal detection unit to detect a reproduction signal of the data segment recorded on the optical disc, and
wherein when the modulation or the asymmetry of the reproduction signal detected by the characteristic detection unit is lower than a predetermined value, the control unit increases the power or the cooling pulse width of the laser beam.

2. The disc apparatus according to claim 1,
wherein the characteristic detection unit comprises a modulation detection unit for detecting the modulation of the reproduction signal and an asymmetry detection unit for detecting the asymmetry of the reproduction signal, and
wherein when the modulation of the reproduction signal detected by the modulation detection unit is lower than a predetermined modulation value, the control unit controls the photoemitter to increase the power of the laser beam, while when the asymmetry of the reproduction signal detected by the asymmetry detection unit is lower than a predetermined asymmetry value, the control unit controls the photoemitter to increase the cooling pulse width of the laser beam.

3. The disc apparatus according to claim 2, wherein the predetermined modulation value is 0.6, while the predetermined asymmetry value is −0.05.
